(19) United States
(12) Patent Application Publication
(10) Pub. No.: US 2015/0124730 A1
(43) Pub. Date: May 7, 2015

(54) MOBILE STATION

(71) Applicant: NTT DOCOMO, INC., Tokyo (JP)

(72) Inventors: Wuri Andarmawanti Hapsari, Tokyo (JP); Kenichiro Aoyagi, Tokyo (JP); Hideaki Takahashi, Tokyo (JP); Sadayuki Abeta, Tokyo (JP)

(73) Assignee: NTT Docomo, Inc., Tokyo (JP)

(21) Appl. No.: 14/401,045

(22) PCT Filed: May 13, 2013
(86) PCT No.: PCT/JP2013/063281

§ 371 Date: Nov. 13, 2014

(30) Foreign Application Priority Data
May 14, 2012 (JP) 2012-110971
Jul. 6, 2012 (JP) 2012-152307

(51) Int. Cl. H04W 74/08

(52) U.S. Cl. CPC H04W 74/0833
USPC 370/329

(57) ABSTRACT

To improve the probability of successfully performing transmission processing by a priority terminal and transmission processing of an emergency call. A mobile station UE according to the present invention includes an RA procedure execution unit 13 configured to transmit “RA Preamble” by the Contention-based method in an RA procedure for transmitting an uplink signal performed when the mobile station UE is in the DRX state, and an access control unit 12 configured to perform ACB on the transmission of “Contention-based RA Preamble”.

### TECHNICAL FIELD

The present invention relates to a mobile station.

### BACKGROUND ART

In a mobile communication system of the LTE (Long Term Evolution), transmission of “RA (Random Access) Request” for transmitting a signal relating to transmission processing (including location registration processing, this also applies hereinafter) such as location registration processing signaling (MO-signalling) or U-plane transmission processing signaling (MO-data) can be restricted by a mobile station UE in an RRC_IDLE state (idle state) by using a mechanism of ACB (Access Class Barring).

### PRIOR ART DOCUMENTS

### Non-Patent Documents

Non-patent Document 1: 3GPP TS36.300
Non-patent Document 2: 3GPP TS36.211
Non-patent Document 3: 3GPP TS36.213
Non-patent Document 4: 3GPP TS36.321
Non-patent Document 5: 3GPP TS36.331

### SUMMARY OF THE INVENTION

However, in a mobile communication system of the conventional LTE, ACB cannot be performed on a transmission of “RA Preamble” in an RA procedure performed by a mobile station UE in an RRC_CONNECTED state (connected state) and a DRX (Discontinuous Reception) state (intermittent reception state) in response to “UL data arrival”, in other words, the transmission of the “RA Preamble” cannot be restricted.

Accordingly, there are problems that “RA preamble” transmitted in an RA procedure for performing transmission processing by a priority terminal or transmission processing of an emergency call during congestion collides with the above-mentioned “RA Preamble” and thereby causes failure of the RA procedure, and depletion of network resources and congestion of processing when returning to the DRX state may cause a delay or failure of the transmission processing.

Thus, the present invention has been made in view of such circumstances and has an objective of providing a mobile station capable of improving the probability of successfully performing transmission processing by a priority terminal and transmission processing of an emergency call even during congestion.

A first feature of the present invention is summarized as a mobile station including: a random access procedure execution unit configured to transmit a random access preamble by a collision method in a random access procedure for transmitting an uplink signal, the random access procedure being performed in an intermittent reception state; and an access control unit configured to perform access restriction on transmission of the random access preamble.

### BRIEF DESCRIPTION OF THE DRAWINGS

FIG. 1 is an overall configuration diagram of a mobile communication system according to a first embodiment of the present invention.

FIG. 2 is a functional block diagram of a mobile station according to the first embodiment of the present invention.

FIG. 3 is a flowchart for illustrating the operation of the mobile station according to the first embodiment of the present invention.

FIG. 4 is a sequence diagram for illustrating the operation of a mobile communication system according to Modification 1 of the present invention.

FIG. 5 is a sequence diagram for illustrating the operation of a mobile communication system according to Modification 2 of the present invention.

FIG. 6 is a sequence diagram for illustrating the operation of a mobile communication system according to Modification 3 of the present invention.

### DETAILED DESCRIPTION

(Mobile Communication System According to the First Embodiment of the Present Invention)

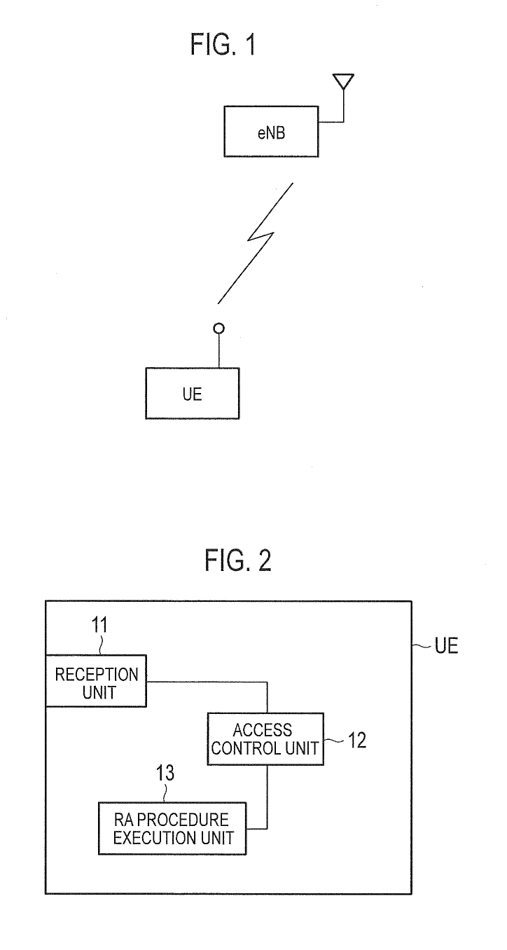

The mobile communication system according to the first embodiment of the present invention will be described with reference to FIGS. 1 to 3.

The mobile communication system according to this embodiment supports the LTE system, and includes a radio base station eNB and a mobile station UE, as shown in FIG. 1.

As shown in FIG. 2, the mobile station UE includes a reception unit 11, an access control unit 12, and an RA procedure execution unit 13.

The reception unit 11 is configured to receive various signals from the radio base station eNB.

For example, the reception unit 11 is configured to acquire a random access channel resource such as “RA Preamble” from the radio base station eNB.

The access control unit 12 is configured to perform ACB (access restriction) on transmission of a signal relating to transmission processing from the mobile station UE.

For example, the access control unit 12 is configured to perform ACB on transmission of “RA Preamble” in an RA procedure for the mobile station UE in an RRC_IDLE state to transmit an uplink signal, and also on transmission of “RA Preamble” in an RA procedure for the mobile station UE in an RRC_CONNECTED state and a DRX state to transmit an uplink signal.

Further, the access control unit 12 may be configured to determine whether or not to perform ACB on transmission of “RA Preamble” in the RA procedure according to restriction information (ac-barring info) broadcasting call types which the network should restrict.

That is, the access control unit 12 may be configured not to restrict transmission of “RA Preamble” in an RA procedure for an emergency call when “MO-Data” or “MO-Signaling” is broadcasted as a call type which the network should restrict.

The access control unit 12 may be configured to determine whether or not to perform ACB on transmission of “RA Preamble” in the RA procedure according to restriction information (ac-barring info) broadcasting an access class (AC) of the mobile station UE which the network should restrict.

For example, the access control unit 12 may be configured not to restrict transmission of “RA Preamble” in an RA procedure for a call (priority call) from the mobile station UE of AC11-15, but to restrict transmission of “RA Preamble” in an RA procedure for a call (normal call) from the mobile station UE of the other AC.

The RA procedure execution unit 13 is configured to perform an RA procedure for a mobile station UE in an RRC_CONNECTED state and in a DRX state or a mobile station UE in an RRC_IDLE state to perform transmission processing.

For example, the RA procedure execution unit 13 may be configured to transmit “RA Preamble” by a contention-based method (collision method) in an RA procedure for a mobile station UE in an RRC_CONNECTED state and in a DRX state to perform transmission processing.

Here, the RA procedure execution unit 13 is configured to perform an RA procedure for the transmission processing by using “Dedicated RA Preamble” or “Common RA Preamble”.

Further, the RA procedure execution unit 13 may be configured not to execute the RA procedure for a predetermined period of time after restricting the above transmission of “RA Preamble”.

Further, the RA procedure execution unit 13 may be configured to cancel “Scheduling Request (scheduling request signal)” transmitted by the radio base station eNB, for a predetermined period of time after restricting the above transmission of “RA Preamble”.

Here, the RA procedure execution unit 13 may be configured to measure the predetermined period of time according to “Back off Timer (a value derived from random numbers).

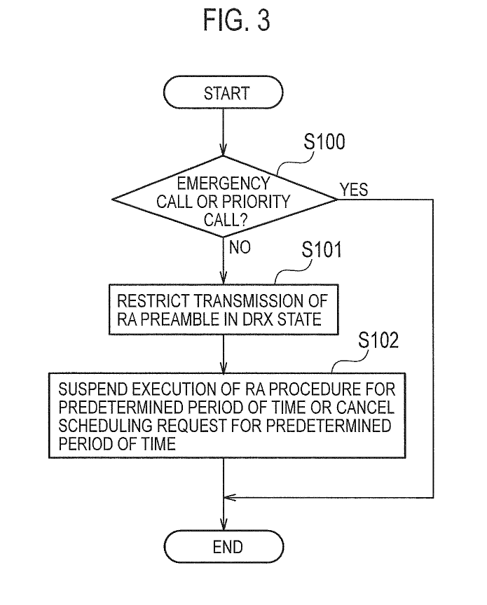

Hereinafter, the operation of a mobile station UE according to this embodiment will be described with reference to FIG. 3.

As shown in FIG. 3, at Step S100, the mobile station UE determines whether the call is an emergency call or a priority call. If “No”, the operation proceeds to Step S101. If “Yes”, the operation ends.

At Step S101, when attempting transmission of an uplink signal in the DRX state, the mobile station UE restricts transmission of “RA Preamble” in an RA procedure for transmitting the uplink signal, by using ACB.

At Step S102, the mobile station UE executes no RA procedure for a predetermined period of time, or cancels “scheduling Request” transmitted by the radio base station eNB.

According to an aspect of this embodiment, transmission of “RA Preamble” in an RA procedure for transmission processing performed by the mobile station UE in the RRC_CONNECTED state and in the DRX state can be restricted. Therefore, even when transmission processing by the mobile station UE in the RRC_CONNECTED state and in the DRX state occurs frequently, probability of successful transmission processing by a priority terminal and transmission processing of an emergency call can be improved.

(Modification 1)

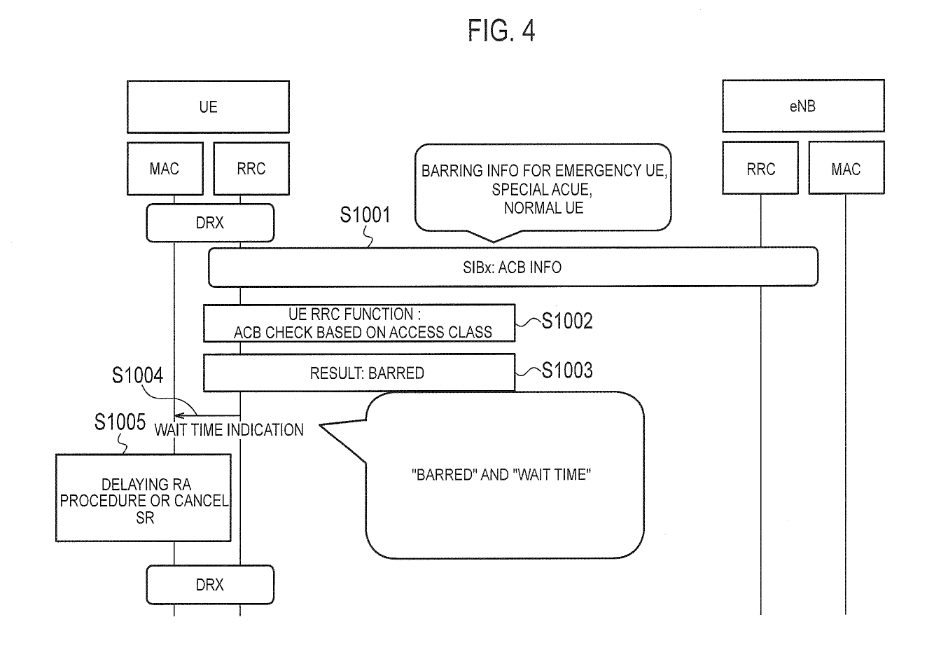

Hereinafter, with reference to FIG. 4, the mobile communication system according to Modification 1 of the present invention will be described by focusing on differences thereof from the mobile communication system according to the first embodiment described above.

When a mobile station UE according to Modification 1 is in an RRC_CONNECTED state (DRX state), the reception unit 11 is configured to receive the above restriction information (ac-barring info) via SIB (System Information Block) broadcasted in the network in an RRC (Radio Resource Control) layer.

Here, the reception unit 11 may be configured to receive the above restriction information (ac-barring info) via SIB2 in the RRC layer or receive the above restriction information (ac-barring info) via newly specified SIB.

When the mobile station UE according to Modification 1 is in the RRC_CONNECTED state (DRX state), the reception unit 11 is configured to definitely receive SIB once during the paging cycle in the RRC layer.

The access control unit 12 may be configured to determine whether or not to perform ACB on transmission of “RA Preamble” in the RA procedure according to the above access class (AC), in the RRC layer.

Further, the access control unit 12 is configured to determine every time SIB broadcasted by the network in the RRC layer is updated.

The access control unit 12 may be configured to, when determined to restrict transmission of “RA Preamble” in an RA procedure in the RRC layer, transmit “barred” and “Wait Time indication” indicating determination of restricting transmission of “RA Preamble” in the RA procedure to the MAC (Media Access Control) layer.

The access control unit 12 may be configured to, when determined to restrict transmission of “RA Preamble” in the RA procedure in the RRC layer, transmit only “Wait Time indication” to the MAC layer.

Here, “Wait Time indication” includes “wait time” indicating the above predetermined period of time, “barred” indicating determination of restricting transmission of “RA Preamble” in the RA procedure, and the like.

The RA procedure execution unit 13 may be configured not to execute the RA procedure for a predetermined period of time when “Wait Time indication” notifying above “wait time” and “barred” is received in the MAC layer.

Alternatively, the RA procedure execution unit 13 may be configured to, when “Wait Time indication” notifying above “wait time” and “barred” is received in the MAC layer, cancel “Scheduling Request” transmitted by the radio base station eNB, for a predetermined period of time.

Here, when “Scheduling Request” is canceled, the RA procedure execution unit 13 may be configured to increment “Scheduling Request Counter” associated with “Scheduling Request”.

Hereinafter, the operation of the mobile communication system according to Modification 1 will be described with reference to FIG. 4.

As shown in FIG. 4, at Step S1001, the radio base station eNB broadcasts the above restriction information via SIB2 or new SIB in the RRC layer.

For example, the restriction information includes emergency call restriction information (Barring info for Emergency UE), priority call restriction information (Barring info for Special AC UE), normal call restriction information (Barring info for Normal UE), and the like.

At Step S1002, the mobile station UE determines whether or not to perform ACB on transmission of “RA Preamble” in the RA procedure in the RRC layer according to the above AC.

For example, when the mobile station UE is a mobile station UE other than the priority terminal and when the transmission of “RA Preamble” for the normal call is determined to be restricted at Step S1003, the mobile station UE transmits “Wait Time indication” notifying the MAC layer of the above “wait time” and “barred” in the RRC layer at Step S1004.

At Step S1005, the mobile station UE executes no RA procedure or cancels “scheduling Request” transmitted by the radio base station eNB, for a predetermined period of time in the MAC layer.

Here, when “Scheduling Request” is canceled, the mobile station UE may increment “Scheduling Request Counter” associated with “Scheduling Request”.

(Modification 2)

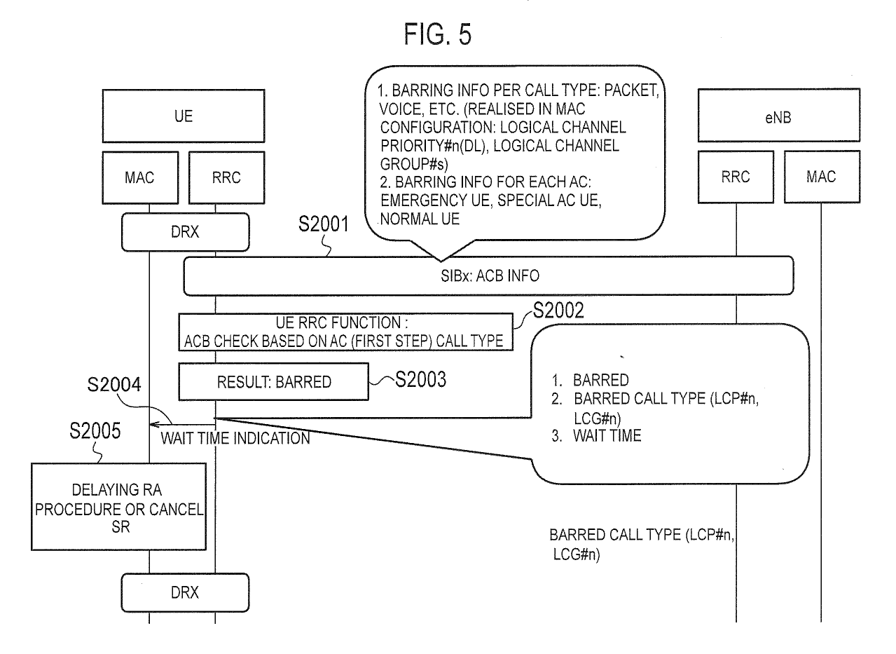

Hereinafter, with reference to FIG. 5, the mobile communication system according to Modification 2 of the present invention will be described by focusing on differences thereof from the mobile communication systems according to the first embodiment and Modification 1 described above.

When a mobile station UE according to Modification 2 is in an RRC_CONNECTED state (DRX state), the reception unit 11 is configured to receive the above restriction information (ac-barring info) via SIB broadcasted in the network, in the RRC layer.

The reception unit 11 is configured to receive “Barring info per call type” as this restriction information in addition to “Barring info for each AC”.

Here, “Barring info for each AC” includes emergency call restriction information (Barring info for Emergency UE), priority call restriction information (Barring info for Special AC UE), normal call restriction information (Barring info for Normal UE), and the like.

“Barring info per call type” includes call-type based restriction information such as “Packet” and “Voice”.

Such a call type is assumed to be specified by “LCP (Logical Channel Priority)” and “LCG (Logical Channel Group)” in the downlink.

The access control unit 12 is configured to, when determined to restrict transmission of “RA Preamble” in the RA procedure in the RRC layer, transmit “Wait Time indication” to the MAC layer.

Here, “Wait Time indication” includes “LCP” and “LCG” specifying the call type to be restricted, in addition to the above “wait time” and “barred”.

Hereinafter, the operation of the mobile communication system according to Modification 2 will be described with reference to FIG. 5.

As shown in FIG. 5, at Step S2001, the radio base station eNB broadcasts the above restriction information via SIB2 or new SIB in the RRC layer.

For example, the restriction information includes the above “Barring info for each AC”, “barring info per call type”, and the like.

At Step S2002, the mobile station UE determines whether or not to perform ACB on the transmission of “RA Preamble” in the RA procedure according to the above AC in the RRC layer.

For example, when the mobile station UE is a mobile station UE other than the priority terminal and when the transmission of “RA Preamble” for the normal call is determined to be restricted at Step S2003, the mobile station UE transmits “Wait Time indication” notifying the MAC layer of the above “wait time”, “barred”, “LCP”, and “LOG” in the RRC layer at Step S2004.

At Step S2005, when “LCP” and “LCG” of data (data to be transmitted) residing in a buffer of a layer 2 in the MAC layer match “LCP” and “LCG” notified by “Wait Time indication”, the mobile station UE executes no RA procedure or cancels “Scheduling Request” transmitted by the radio base station eNB, for a predetermined period of time.

(Modification 3)

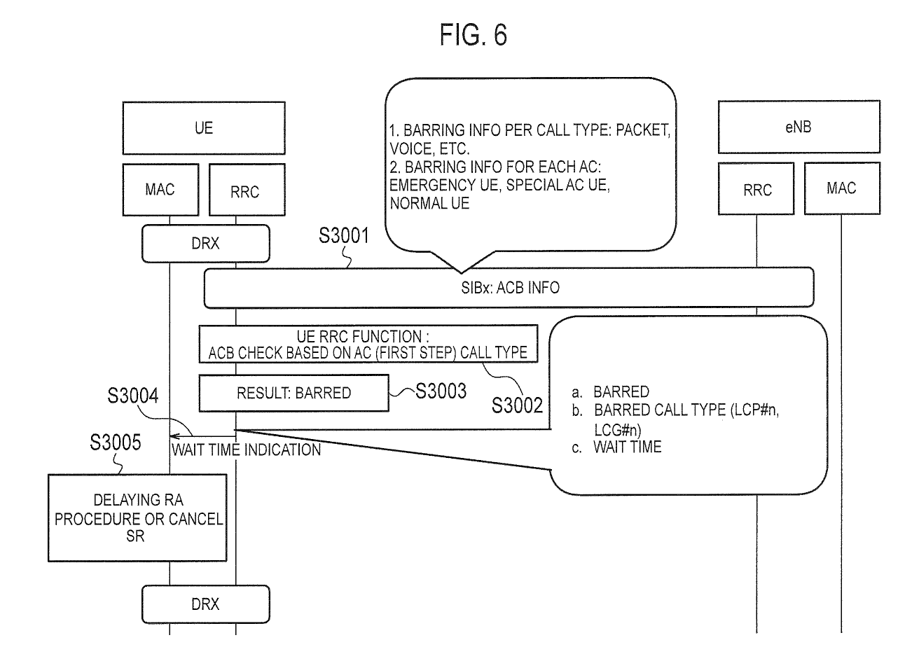

Hereinafter, a mobile communication system according to Modification 3 of the present invention will be described with reference to FIG. 6 by focusing on differences thereof from the mobile communication systems according to Modifications 1 and 2.

Hereinafter, the operation of the mobile communication system according to Modification 3 will be described with reference to FIG. 6.

As shown in FIG. 6, at Step S3001, the radio base station eNB broadcasts the above restriction information via SIB2 or a new SIB in the RRC layer.

For example, the restriction information includes the above “Barring info for each AC”, “Barring info per call type”, and the like.

At Step S3002, the mobile station UE determines whether or not to perform ACB on transmission of “RA Preamble” in the RA procedure according to the above AC, in the RRC layer.

For example, when the mobile station UE is a mobile station UE other than the priority terminal and restricting transmission of “RA Preamble” for the normal call is determined at Step S2003, the mobile station UE extracts “LCP” and “LCG” corresponding to the call type (for example, “Packet”) to be restricted, in the RRC layer.

At Step S2004, the mobile station UE transmits “Wait Time indication” notifying the MAC layer of the above “wait time”, “barred”, “LCP”, and “LCG” in the RRC layer.

At Step S2005, when “LCP” and “LCG” of data (data to be transmitted) residing in a buffer of the layer 2 in the MAC layer match with “LCP” and “LCG” notified by “Wait Time indication”, the mobile station UE execute no RA procedure or cancel “Scheduling Request” transmitted by the radio base station eNB, for a predetermined period of time.

The features of the present embodiment may also be expressed as follows.

A first feature of this embodiment is summarized as a mobile station UE including: an RA procedure execution unit (a random access procedure execution unit) 13 configured to transmit “RA Preamble (a random access preamble)” by a Contention-based method (a collision method) in an RA procedure (a random access procedure) for transmitting an uplink signal, the random access procedure being performed in a DRX state (an intermittent reception state); and an access control unit 12 configured to perform ACB (access restriction) on transmission of “RA Preamble.”

In the first feature of this embodiment, the RA procedure execution unit 13 may be configured not to execute the RA procedure for a predetermined period of time after restricting transmission of “RA Preamble.”

In the first feature of this embodiment, the RA procedure execution unit 13 may be configured to cancel “Scheduling Request (a scheduling request signal)” transmitted by a radio base station eNB, for a predetermined period of time after restricting transmission of “RA Preamble.”

In the first feature of this embodiment, the access control unit 12 may be configured not to restrict transmission of “RA Preamble” for an emergency call or a priority call, and to perform ACB on transmission of “RA Preamble” for other calls.

In the first feature of this embodiment, the access control unit 12 may be configured to perform ACB in an RRC layer; and the RA procedure execution unit 13 may be configured not to execute the RA procedure for a predetermined period of time after restricting transmission of “RA Preamble” in a MAC layer.

In the first feature of this embodiment, the access control unit 12 may be configured to perform ACB in an RRC layer; and the RA procedure execution unit 13 may be configured to cancel “Scheduling Request” for a predetermined period of time after restricting transmission of “RA Preamble” in a MAC layer.

It should be noted that the foregoing operations of the mobile station UE and the radio base station eNB may be implemented by hardware, may be implemented by a software module executed by a processor, or may be implemented in combination of the two.

The software module may be provided in a storage medium in any format, such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

The storage medium is connected to a processor so that the processor can read and write information from and to the storage medium. Instead, the storage medium may be integrated in a processor. The storage medium and the processor may be provided inside an ASIC. Such an ASIC may be provided in the mobile station UE and the radio base station eNB. Otherwise, the storage medium and the processor may be provided as discrete components inside the mobile station UE and the radio base station eNB.

Hereinabove, the present invention has been described in detail by use of the foregoing embodiments. However, it is apparent to those skilled in the art that the present invention should not be limited to the embodiments described in the specification. The present invention can be implemented as an altered or modified embodiment without departing from the spirit and scope of the present invention, which are determined by the description of the scope of claims. Therefore, the description of the specification is intended for illustrative explanation only and does not impose any limited interpretation on the present invention.

Note that the entire contents of Japanese Patent Application No. 2012-110971 (filed on May 14, 2012) and Japanese Patent Application No. 2012-152307 (filed on Jul. 6, 2012) are incorporated by reference in the present specification.

### INDUSTRIAL APPLICABILITY

As described above, an aspect of the present invention provides a mobile station capable of improving the probability of successfully performing transmission processing by a priority terminal and transmission processing of an emergency call even during congestion.

### EXPLANATION OF THE REFERENCE NUMERALS

UE mobile station
eNB radio base station
11 reception unit
12 access control unit
13 RA procedure execution unit

1. A mobile station comprising:
a random access procedure execution unit configured to transmit a random access preamble by a collision method in a random access procedure for transmitting an uplink signal, the random access procedure being performed in an intermittent reception state; and
an access control unit configured to perform access restriction on transmission of the random access preamble.

2. The mobile station according to claim 1, wherein the random access procedure execution unit is configured not to execute the random access procedure for a predetermined period of time after restricting transmission of the random access preamble.

3. The mobile station according to claim 1, wherein the random access procedure execution unit is configured to cancel a scheduling request signal transmitted by a radio base station, for a predetermined period of time after restricting transmission of the random access preamble.

4. The mobile station according to claim 1, wherein the access control unit is configured not to restrict transmission of a random access preamble for an emergency call or a priority call, and to perform the access restriction on transmission of random access preambles for other calls.

5. The mobile station according to claim 2, wherein the access control unit is configured to perform the access restriction in an RRC (Radio Resource Control) layer; and
wherein the random access procedure execution unit is configured not to execute the random access procedure for a predetermined period of time after restricting transmission of the random access preamble in a MAC (Media Access Control) layer.

6. The mobile station according to claim 3, wherein the access control unit is configured to perform the access restriction in an RRC (Radio Resource Control) layer; and
wherein the random access procedure execution unit is configured to cancel the scheduling request signal transmitted by the radio base station, for a predetermined period of time after restricting transmission of the random access preamble in a MAC (Media Access Control) layer.
